(19) United States
(12) Patent Application Publication
(10) Pub. No.: US 2011/0016107 A1
(43) Pub. Date: Jan. 20, 2011

(54) Execution of query plans for database query within environments of databases

(76) Inventors: Harumi Kuno, Cupertino, CA (US); Murali Mallela Krishna, Vancouver, WA (US); Umeshwar Dayal, Saratoga, CA (US); Meichun Hsu, Los Altos, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/505,503

(22) Filed: Jul. 19, 2009

(51) Int. Cl. G06F 17/30

(52) U.S. Cl. 707/718; 707/E17.136

(57) ABSTRACT

A database query is submitted to a first query optimizer to receive a first query plan from the first query optimizer. The first query plan is set as a current query plan. As an entry point, the current query plan is executed against the database within a given environment of the database. Where execution of the current query plan within the given environment is problematic, the execution of the current query plan is prematurely terminated, and the database query is submitted to a second query optimizer. Where a second query plan that is different than any previous query plan for the database query has been received from the second query optimizer, the second query plan is set as the current query plan, and a risk to the database in executing the current query plan is determined. Where the risk is less than a threshold, the entry point is proceeded to.

### BACKGROUND

A database is a structured collection of data stored within a computing system. To retrieve desired data from the database, a corresponding query is formulated and submitted to a query optimizer. The query optimizer attempts to generate an efficient way to execute the query against the database, which is referred to as a query plan. As such, the query plan is a series of steps that are executed to effect the query. Once the query plan has been generated, the query plan is thus executed against the database to retrieve the desired data.

### BRIEF DESCRIPTION OF THE DRAWINGS

FIGS. 1, 2, and 3 are flowcharts of methods, according to differing embodiments of the present disclosure.

FIG. 4 is a diagram depicting how the risk of a query plan to a database is assessed against two different thresholds in the method of FIG. 3, according to an embodiment of the present disclosure.

FIG. 5 is a diagram of a representative database management system, according to an embodiment of the present disclosure.

### DETAILED DESCRIPTION

As noted in the background section, to retrieve desired data from a database, a query is formulated and submitted to a query optimizer, which generates a query plan that is then executed against the database to effect the query. A query optimizer is a complex component of a database management system. In a production environment in which end users formulate queries for submission against a database, for what may be mission-critical tasks of an organization of which the end users are a part, the query optimizer may produce query plans that represent years of hand-coded optimizations, ensuring that efficient query plans are generated for the queries.

Database manufacturers are reluctant to substitute untested and unproven query optimizers for their existing and proven query optimizers, even if the alternative query optimizers promise improved performance and other benefits. The risk of an untested and unproven query optimizer causing problems within the production environment of the database may be considered too great. Improvements in performance and other benefits thus may be realized relatively slowly, because lengthy testing of an alternative query optimizer may have to be conducted before sufficient confidence is gained to deploy the query optimizer within a production environment without problems.

A query optimizer generates a query plan for a database query in an automated manner. That is, a query optimizer does not require user assistance in generating a query plan. However, for some types of queries, a query optimizer may be unable to generate an appropriate query plan. In these instances, an administrator is alerted that manual optimization, or hand optimization, of the query is needed to generate an appropriate query plan for the query. This situation is inconvenient for the end user, because he or she has to wait for an experienced person to generate a query plan by hand, which itself can be a tedious and time-consuming process.

Embodiments of the present disclosure provide a way to test alternative query optimizers in a quicker fashion, without incurring undue risk in the production environment of a database. Embodiments further minimize the situations in which manual or hand optimization of a query is needed to generate a query plan for the query. In particular, an existing, typically proven, query optimizer may be used to generate a query plan. However, if the query plan generated by this query optimizer is problematic in its execution, then an alternative query optimizer may be used to generate an alternative query plan. The alternative query plan may be executed if it is not overly risky. In one embodiment, just when the alternative query optimizer fails to generate an alternative query plan that is not overly risky and that is executed without problems is manual optimization of the query performed. In this way, the alternative query optimizer is tested more quickly to gain confidence in the alternative query optimizer, while minimizing the need for manual optimization to be performed.

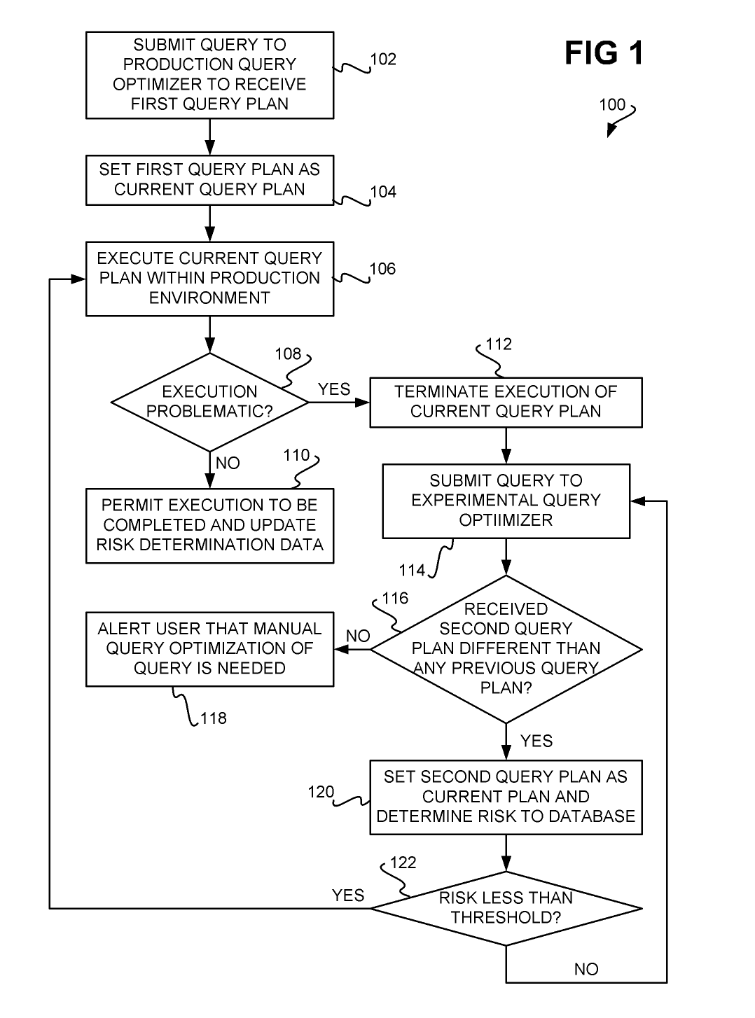

FIG. 1 shows a method 100, according to an embodiment of the disclosure. Like other methods of embodiments of the disclosure, the method 100 may be implemented as one or more computer programs stored on one or more computer-readable media. The computer-readable media may be non-volatile media, such as magnetic media like hard disk drives and non-volatile semiconductor memory like flash memory, as well as volatile media, such as volatile semiconductor memory like dynamic random access memory, and/or other types of computer-readable media. One or more processors of one or more computing devices execute the computer programs to perform the method 100.

A database query is submitted to a production query optimizer, to receive a first query plan from the production query optimizer (102). The database query is formulated by a user to request particular data to be returned from a database. The production query optimizer is more generally a first query optimizer. The production query optimizer operates in a production environment of the database, which is more generally a first environment of the database. The production environment of the database is the environment in which query plans for queries are normally executed to return data from the database as requested by the queries. A query plan is a set of steps that are executed against the database to return the particular data being requested by a corresponding query. The first query plan may be considered a production query plan, in that the production query optimizer has generated the first query plan.

The first query plan is set as the current query plan (104), and the current query plan is executed within a production environment of the database (106). However, execution of the current query plan can result in problems occurring. For example, execution of the current query plan may be determined as being problematic if the production environment, for instance, reports that its execution is taking too long, is returning too much data, is taking too many processing cycles, and so on, among other types of problems.

If execution of the current plan is not problematic (108), then it is permitted to be completed, at which time risk determination data is updated (110). For example, the current query plan may be marked as not posing a risk to the database when executed, as part of this risk determination data. The method 100 thus ends at part 110. If execution of the current plan is problematic (108), though, then it is prematurely terminated and not permitted to run until completion (112), and the database query is submitted to an experimental query optimizer to desirably receive a second query plan (114).

The experimental query optimizer is more generally a second query optimizer. The experimental query optimizer may be a completely different query optimizer than the production query optimizer is, or it may be part of the production query optimizer, but configured to generate different types of query plans when used as the experimental query optimizer. In the later case, the production query optimizer may have a production mode to generate production query plans, as in part 102, and an experimental mode to generate experimental query plans, as in part 114. The experimental query optimizer, whether it is a separate optimizer or part of the production optimizer, is an optimizer that may not yet have been sufficiently tested to be considered as generating sufficiently well crafted query plans that are production query plans. Rather, the experimental query optimizer may currently be undergoing testing to determine whether it should be deployed within the production environment in such a way as to generate production query plans.

There are three possible alternatives in the response received from the experimental query optimizer. First, no second query plan may be received; that is, the experimental query optimizer may be unable to generate a query plan from the database query. Second, a second query plan may be received, but one that is duplicative, or substantially duplicative, of a previous query plan that has been generated by either the experimental query optimizer or the production query optimizer. Third, a second query plan may be received that is different than any previous query plan that has been generated.

If a second query plan is received, and which is different than any previous query plan (116), then this second query plan is set as the current query plan and the risk of this new current query plan to the database is determined (120). The risk may be determined using at least in part the risk determination data that is updated in part 110. The risk may be considered a quantifiable measure of the potential for problems occurring within the database—and more specifically, within the production environment of the database—as a result of the current query plan being executed. The risk may be denoted in any of a number of different ways.

For example, the experimental query optimizer may provide a measure of the amount of data that has to be examined within the database to execute the current query plan in order to return the particular data being requested by the database query. In this case, the amount of data can serve as the risk that is determined. As another example, the experimental query optimizer may provide a measure of the number of processor cycles that have to be expended by one or more processors to execute the current query plan in order to return the particular data being requested by the database query. In this case, the number of processor cycles can serve as the risk that is determined.

The risk may also be determined apart from the experimental query optimizer. For example, the current query plan may be examined to determine whether its execution is likely to cause the production environment to inordinately slow down to return the particular data being requested by the database query. Each step of the current query plan may be examined individually or in combination with the other steps to make such a determination. Risk assessment may be also be achieved by more complex approaches, such as by using an appropriately trained machine learning model to quantify the risk of a query plan.

If the risk of the current query plan to the database is less than a threshold (122), then the method 100 proceeds back to part 106, where the current query plan is executed as before. However, if the risk is greater the threshold (122), then the method 100 proceeds back to part 1 14, where the database query is again submitted to the experimental query optimizer to determine whether a new query plan that is not as risky can be constructed. Ultimately, if the experimental query optimizer is unable to generate a second query plan that is not identical to any previous query plan generated by either the experimental query optimizer or the production query optimizer (116), then the user is alerted that manual, or hand, optimization of the database query is needed (118).

The method 100 thus ends at part 118 without having executed a query plan without problems to effect the database query and return the particular data being requested by the query. Rather, the initial current query plan was problematic in its execution, and the experimental query optimizer could not generate a subsequent current query plan that was not too risky and that was not problematic in its execution. It is noted, therefore, that hand optimization having to be performed is minimized within the method 100. Even if the production query optimizer cannot generate a query plan that executes without problems, hand optimization does not necessarily have to be performed. Rather, the experimental query optimizer is given the opportunity to generate a query plan that is of sufficiently low risk and that executes without problems, in which case hand optimization does not have to be performed.

It is further noted that the method 100 permits the experimental query optimizer to be tested along with normal utilization of the production query optimizer. The experimental query optimizer is employed to generate query plans where the production query optimizer is unable to generate a query plan that executes without problems. As such, the experimental query optimizer is tested during successive performances of the method 100. A history of the types of query plans that the experimental query optimizer generates can thus be collected, which can ultimately quicken the pace at which confidence is gained in the experimental query optimizer, with an eye towards promoting the experimental query optimizer to generate production query plans.

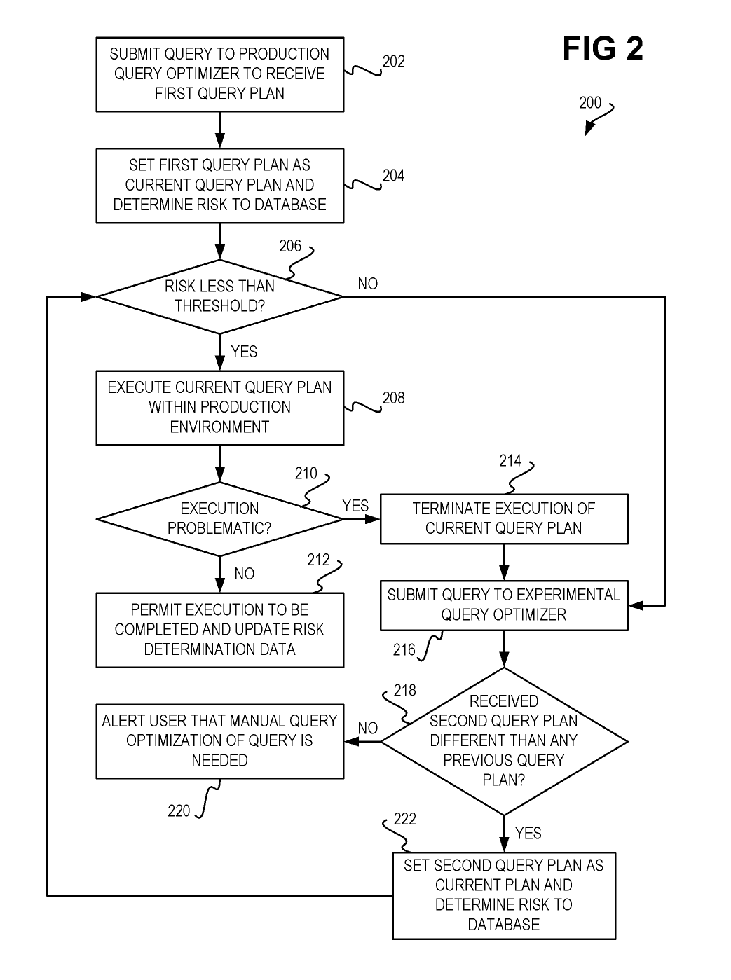

FIG. 2 shows a method 200, according to another embodiment of the disclosure. The difference between the method 200 and the method 100 is that the method 200 also determines the risk of the first query plan generated by the production query optimizer, and permits the first query plan to be executed just if this risk is less than the threshold. As such, a database query is submitted to the production query optimizer to receive a first query plan (202). The first query plan is set as the current query plan, and the risk in executing the current query plan to the database is determined (204).

If the risk is less than the threshold (206), then the current query plan is executed within the production environment (208). If execution of the current query plan is not problematic (210), then it is permitted to be completed, and the risk determination data is updated (212). The risk determination data is the data on which basis the risk of the current query plan is determined in part 204, as well as in part 222. However, if execution of the current query plan becomes problematic (210), then it is prematurely terminated and is not permitted to run until completion (214).

From either part 214, or from part 206 where the determined risk is greater than the threshold, the method 200 submits the database query to the experimental query optimizer to desirably receive a second query plan (216). If a second query is indeed received, and which is different than any previous query plan generated by the production query optimizer or the experimental query optimizer (218), then the second query plan is set as the current query plan and the risk in executing this new current query plan to the database is determined (222). The method 200 then proceeds back to part 206, as before. However, if a second query plan that is different than any previous query plan is not received (218), then the user is alerted that manual query optimization of the database query is needed (220).

It is noted, therefore, that hand optimization having to be performed is also minimized within the method 200, similar to within the method 100. Even if the production query optimizer cannot generate a query plan that is not overly risky and that executes without problems, hand optimization does not necessarily have to be performed. Rather, the experimental query optimizer is given the opportunity to generate a query plan that is of sufficiently low risk and that executes without problems, in which case hand optimization does not have to be performed.

It is further noted that like the method 100, the method 200 permits the experimental query optimizer to be tested along with normal utilization of the production query optimizer. The experimental query optimizer is employed to generate query plans where the production query optimizer is unable to generate a query plan that is not overly risky and that executes without problems. As such, the experimental query optimizer is tested during successive performances of the method 100. A history of the types of query plans that the experimental query optimizer generates can thus be collected, which can ultimately quicken the pace at which confidence is gained in the experimental query optimizer, with an eye towards promoting the experimental query optimizer to generate production query plans.

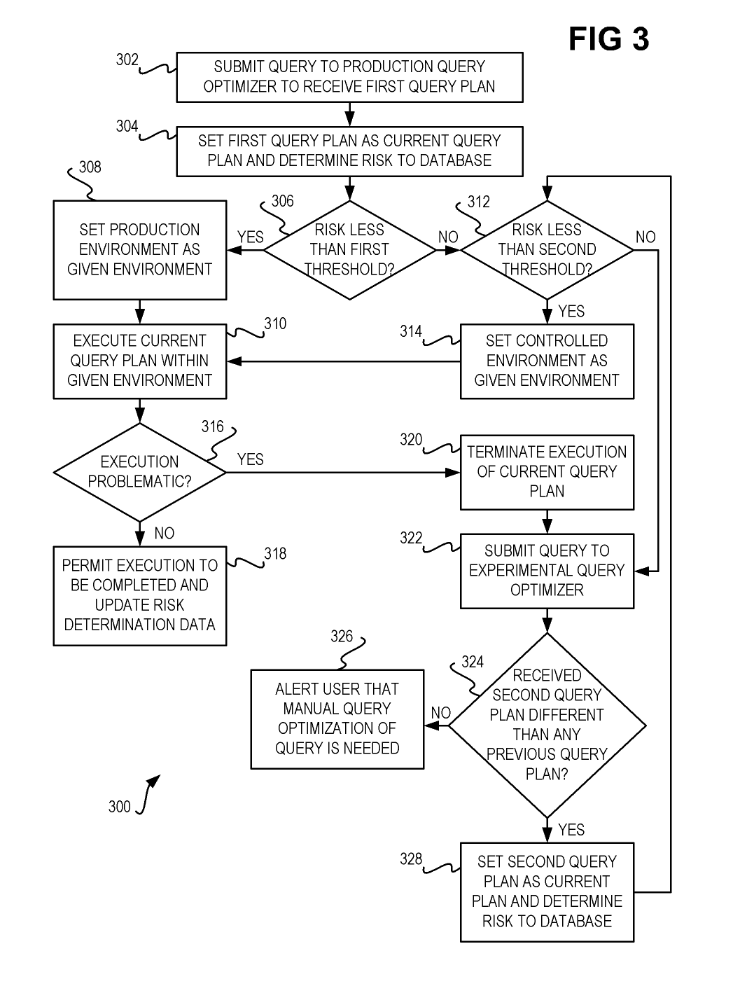

FIG. 3 shows a method 300, according to another embodiment of the disclosure. The difference between the method 300 and the method 200 is primarily twofold. First, production query plans generated by the production query optimizer are executed within the production environment if they pose relatively little risk. If the production query plans are risky, but not overly risky, then the production query plans are instead executed within a controlled environment. Second, experimental query plans generated by the experimental query optimizer are never executed within the production environment, but rather, if they are not overly risky, are executed within the controlled environment, too.

In one embodiment, the controlled environment of the database is a different environment than the production environment of the database is. The controlled environment is the environment in which query plans for queries are tested before they are permitted to be executed within the production environment. The controlled environment may be run on different hardware than the production environment, for instance, against a copy of the database, so that the production environment is not distributed. Furthermore, the controlled environment may be such that execution of query plans are closely monitored and logged, so that where and how the execution of a query plan causes a problem (if any) can be determined easily.

However, in another embodiment, the controlled environment of the database may be part of the production environment of the database. Instead of normally executing queries as is typical within the production environment, a query plan flagged for execution within the controlled environment has its execution closely monitored and logged, so that where and how the execution of the query plan causes a problem (if any) can be determined easily. As such, a query plan that executes normally within the production environment may be executed more quickly than a query plan that executes within the production environment where the production environment is also serving as the controlled environment.

A database query is thus submitted to the production query optimizer to receive a first query plan (302). The first query plan is set as the current query plan, and the risk in executing the current query plan to the database is determined (304). The risk is compared against a first threshold and against a second threshold, where the second threshold is greater than the first threshold. Where the risk is lower than the first threshold, then this means that the risk in executing the current query plan is acceptable. Where the risk is between the first and the second thresholds, then this means that the risk in executing the current query plan is heightened, and is too risky to execute within the production environment. Where the risk is greater than the second threshold, then this means that the risk in executing the current query plan is too great to even execute within an environment other than the production environment, such that the current query plan is discarded.

Therefore, if the risk is less than the first threshold (306), the production environment is set as a given environment (308), and the current query plan is executed within the given environment (310). By comparison, if the risk is not less than the first threshold but is less than the second threshold (312), then a controlled environment is set as the given environment (314), and the current query plan is executed within the given environment (310). The controlled environment is more generally referred to as a second environment.

If execution of the current query plan is not problematic (316), then it is permitted to be completed, and the risk determination data is updated (318). The risk determination data is the data on which basis the risk of the current query plan is determined in part 304, as well as in part 328. However, if execution of the current query plan becomes problematic (316), then it is prematurely terminated and is not permitted to run until completion (320).

From either part 320, or from part 312 where the determined risk of the current query plan is greater than the second threshold, the method 300 submits the database query to the experimental query optimizer to desirably receive a second query plan (322). If a second query is indeed received, and which is different than any previous query plan generated by the production query optimizer or the experimental query optimizer (324), then the second query plan is set as the current query plan and the risk in executing this new current query plan to the database is determined (328). The method 300 then proceeds back to part 312. However, if a second query plan that is different than any previous query plan is not received (324), then the user is alerted that manual query optimization of the database query is needed (326).

It is noted, therefore, that hand optimization having to be performed is also minimized within the method 300, similar to the methods 100 and 200. Even if the production query optimizer cannot generate a query plan that is of sufficiently low risk and that executes without problems, hand optimization does not necessarily have to be performed. Rather, the experimental query optimizer is given the opportunity to generate a query plan that is of sufficiently low risk and that executes without problems, in which case hand optimization does not have to be performed.

It is further noted that like the methods 100 and 200, the method 300 permits the experimental query optimizer an opportunity to be tested along with normal utilization of the production query optimizer. The experimental query optimizer is employed to generate query plans where the production query optimizer is unable to generate a query plan that is of sufficiently low risk and that executes without problems. As such, the experimental query optimizer is tested during successive performances of the method 300. A history of the types of query plans that the experimental query optimizer generates can thus be collected, which can ultimately quicken the pace at which confidence is gained in the experimental query optimizer, with an eye towards promoting the experimental query optimizer to be a production query optimizer.

However, because the experimental query optimizer may not yet have been proven, it is not permitted within the method 300 to have its query plans be executed within the production environment. For instance, even if the risk of a query plan generated by the experimental query optimizer is less than the first threshold—which would ordinarily result in execution of the query plan within the production environment if the plan had been generated by the production query optimizer—the query plan is not compared to the first threshold in part 306. Rather, a query plan generated by the experimental query optimizer is compared just to the second threshold in part 312. As such, there are just two alternatives for a query plan generated by the experimental query optimizer: either being executed within the controlled environment, or being discarded such that the experimental query optimizer attempts to generate a different query plan.

By comparison, a query plan generated by the production query optimizer may be compared to both the first threshold, in part 306, as well as to the second threshold in part 312. As such, there are three alternatives for a query plan generated by the production query optimizer in the method 300. First, the query plan may be executed within the production environment. Second, the query plan may be executed within the controlled environment. Third, the query plan may be discarded such that the experimental query optimizer attempts to generate a different query plan.

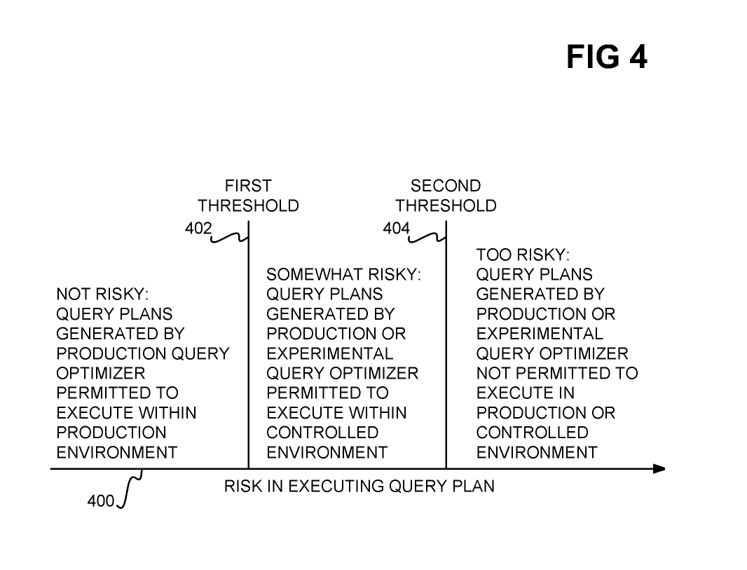

FIG. 4 graphically depicts how the method 300 assesses the risk of a query plan, according to an embodiment of the disclosure. A horizontal line 400 represents the risk in executing a query plan on the database, where the risk increases from left to right. The first threshold is represented by a vertical line 402, whereas the second threshold is represented by a vertical line 404. Because the vertical line 402 is to the left of the vertical line 404, the first threshold is less than the second threshold.

A query plan that has a risk less than the first threshold is considered not to be risky. Such a query plan is generated by the production query optimizer; a query plan generated by the experimental query optimizer is not compared against the first threshold. A query plan generated by the production query optimizer and that has such a risk less than the first threshold is permitted to execute within the production environment.

A query plan that has a risk greater than the first threshold but less than the second threshold is considered to be somewhat risky. Such a query plan is generated by the production query optimizer or by the experimental query optimizer. A query plan having a risk between the first and the second thresholds is permitted to execute within just the controlled environment, since it is deemed to be too risky to execute within the production environment.

A query plan that has a risk greater than the second threshold is considered too risky to execute. Such a query plan is generated by the production query optimizer or by the experimental query optimizer. A query plan having a risk greater than the second threshold is not permitted to execute within the controlled environment, let alone the production environment.

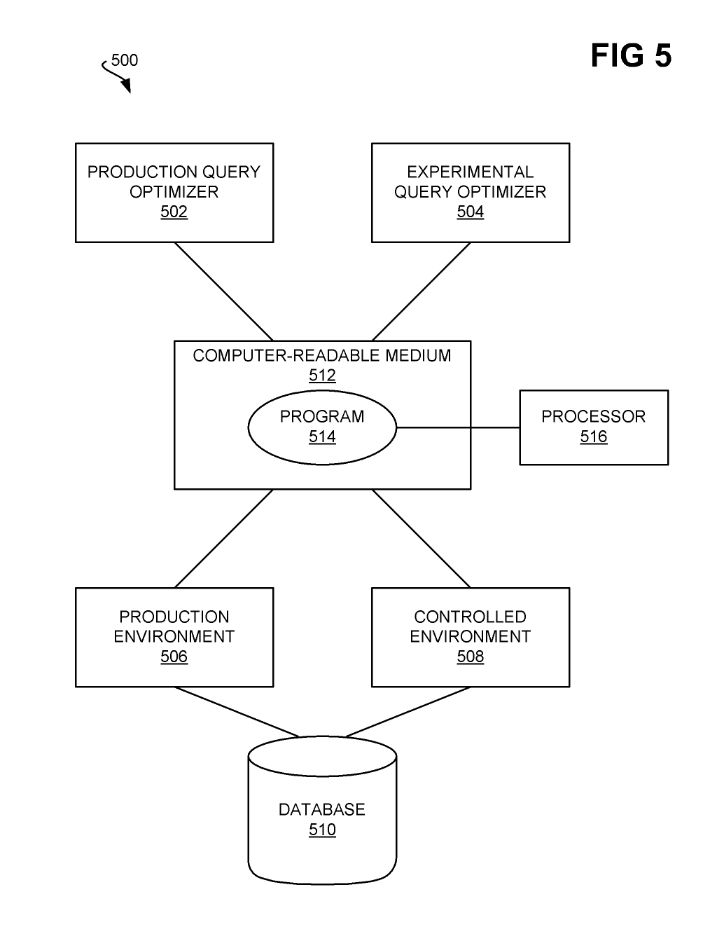

In conclusion, FIG. 5 shows a system 500 in conjunction with which the methods 100, 200, and 300 may be implemented, according to an embodiment of the disclosure. The system 500 may be implemented over one or more computing devices in one embodiment. In the case where the system 500 is implemented via more than one computing device, the computing devices may be communicatively connected to one another over a network.

The system 500 includes a production query optimizer 502, an experimental query optimizer 504, a production environment 506 for a database 510, a controlled environment 508 for the database 510, a computer-readable medium 512 that stores a computer program 514, and a processor 516 that executes the program 514. The production query optimizer 502 generates a query plan from a database query, as does the experimental query optimizer 504. The query optimizers 502 and 504 can each be implemented in software, hardware, or a combination of hardware and software.

The production environment 506 for the database 510 is the environment within which query plans for queries are normally executed against the database 510, as has been described. The controlled environment 508 for the database 510 is also an environment within which query plans for queries are execute against the database 510, but differs from the production environment 506. For example, the controlled environment 508 may permit the query plans to be more closely monitored when executed, such that when or how the query plans cause problems can be determined when such problems occur. The controlled environment 508 may operate on the same or a different computing device than the production environment 506, and may operate on the same or a different copy of the database 510 than the production environment 506.

The computer-readable medium 512 can include a volatile computer-readable medium, like volatile semiconductor memory, and/or a non-volatile computer-readable medium, like a hard disk drive or non-volatile semiconductor memory. The computer program 514 stored on the computer-readable medium 512 and executed by the processor 516 performs the methods 100, 200, and/or 300 that have been described. The computer program 514 thus permits the experimental query optimizer 504 to be tested alongside usage of the production query optimizer 502, as has been described above in relation to the methods 100, 200, and 300.

We claim:

1. A method comprising:
submitting a database query to a first query optimizer to receive a first query plan from the first query optimizer;
setting the first query plan as a current query plan;
as an entry point of the method, executing the current query plan against the database within a given environment of the database;
where execution of the current query plan within the given environment of the database is problematic,
prematurely terminating the execution of the current query plan;
submitting the database query to a second query optimizer;
where a second query plan that is different than any previous query plan for the database query has been received from the second query optimizer,
setting the second query plan as the current query plan;
determining a risk to the database in executing the current query plan; and,
where the risk is less than a threshold, proceeding to the entry point.

2. The method of claim 1, wherein the first query optimizer is a production query optimizer that has been deployed within the production environment to generate production query plans for queries, and
wherein the second query optimizer is an experimental query optimizer that is being tested to determine whether to deploy the second query optimizer within the production environment to generate production query plans for queries.

3. The method of claim 1, wherein the first query optimizer is a production query optimizer that has been deployed within the production environment to generate production query plans for queries, and
wherein the second query optimizer is a part of the production query optimizer, but to generate different types of query plans when used as the second query optimizer than when the production query optimizer is used as the first query optimizer.

4. The method of claim 1, further comprising, where the execution of the current plan within the given environment of the database is not problematic,
permitting execution of the current query plan to be completed; and,
updating risk determination data based on completion of execution of the current query plan, the risk determination used to determine a risk to the database in executing at least the current query plan.

5. The method of claim 1, further comprising, wherein the execution of the current plan within the given environment of the database is problematic, and where a second query plan that is different than any previous query plan for the database query has not been received from the second query optimizer,
alerting a user of the database that manual optimization of the query is needed to generate a query plan.

6. The method of claim 1, wherein the entry point of the method is a first entry point of the method, wherein submitting the database query to the second query optimizer is a second entry point of the method, and wherein the method further comprises:
where the execution of the current plan within the given environment of the database is problematic, where a second query plan that is different than any previous query plan for the database query has been received from the second query optimizer, and where the risk is greater than the threshold,
proceeding to the second entry point.

7. The method of claim 1, wherein the entry point of the method is a first entry point of the method, wherein submitting the database query to the second query optimizer is a second entry point of the method, and wherein the method further comprises:
after setting the first query plan as the current query plan:
determining the risk to the database in executing the current query plan;
where the risk is less than the threshold, proceeding to the first entry point; and,
where the risk is greater than the threshold, proceeding to the second entry point.

8. The method of claim 1, wherein the threshold is a second threshold wherein the entry point of the method is a first entry point of the method, wherein submitting the database query to the second query optimizer is a second entry point of the method, and wherein the method further comprises:
after setting the first query plan as the current query plan:
determining the risk to the database in executing the current query plan;
where the risk is less than a first threshold, the first threshold less than the second threshold,
setting a first environment of the database as the given environment of the database;
proceeding to the first entry point;
where the risk is greater than the first threshold and less than the second threshold,
setting a second environment of the database as the given environment of the database;
proceeding to the first entry point;
where the risk is greater than the second threshold
proceeding to the second entry point.

9. The method of claim 8, further comprising, where a second query plan that is different than any previous query plan for the database has been received from the second query optimizer, after setting the second query plan as the current query plan,
setting the second environment of the database as the given environment of the database.

10. The method of claim 8, wherein the first environment of the database is a production environment of the database in which query plans for queries are normally executed, and
wherein the second environment of the database is a controlled environment of the database in which query plans for queries are tested before permitting the query plans to be executed within the production environment of the database.

11. The method of claim 8, wherein the first environment of the database is a production environment of the database in which query plans for queries are normally executed, and
wherein the second environment is also the production environment of the database, but in which the production environment has been adapted to be permit monitoring of the query plans during execution of the query plans within the production environment.

12. A system comprising:
a first query optimizer to generate a first query plan from a database query;
a second query optimizer to generate a second query plan from the database query;
a processor; and,
a computer-readable medium to store a computer program for execution by the processor to:
set the first query plan as a current query plan and determine a risk to the database in executing the current query plan;
as a first entry point, execute the current query plan against the database;
where the risk is greater than a threshold, set the second query plan as the current query plan, determine the risk to the database in executing the current query plan, and where the risk is less than a threshold, proceed to the first entry point.

13. A computer-readable medium having a computer program stored thereon for execution by a processor to perform a method comprising:
submitting a database query to a first query optimizer to receive a first query plan from the first query optimizer;
setting the first query plan as a current query plan;
as an entry point of the method, executing the current query plan against the database within a given environment of the database;
where execution of the current query plan within the given environment of the database is problematic,
prematurely terminating the execution of the current query plan;
submitting the database query to a second query optimizer;
where a second query plan that is different than any previous query plan for the database query has been received from the second query optimizer,
setting the second query plan as the current query plan;
determining a risk to the database in executing the current query plan; and,
where the risk is less than a threshold, proceeding to the entry point.

14. The computer-readable medium of claim 13, wherein the entry point of the method is a first entry point of the method, wherein submitting the database query to the second query optimizer is a second entry point of the method, and wherein the method further comprises:
after setting the first query plan as the current query plan:
determining the risk to the database in executing the current query plan;
where the risk is less than the threshold, proceeding to the first entry point; and,
where the risk is greater than the threshold, proceeding to the second entry point.

15. The computer-readable medium of claim 13, wherein the threshold is a second threshold, wherein the entry point of the method is a first entry point of the method, wherein submitting the database query to the second query optimizer is a second entry point of the method, and wherein the method further comprises:
after setting the first query plan as the current query plan:
determining the risk to the database in executing the current query plan;
where the risk is less than a first threshold, the first threshold less than the second threshold,
setting a first environment of the database as the given environment of the database;
proceeding to the first entry point;
where the risk is greater than the first threshold and less than the second threshold,
setting a second environment of the database as the given environment of the database;
proceeding to the first entry point;
where the risk is greater than the second threshold
proceeding to the second entry point.
